(19) United States
(12) Patent Application Publication
(10) Pub. No.: US 2024/0348647 A1
(43) Pub. Date: Oct. 17, 2024

(54) DETERMINATION METHOD, COMPUTER-READABLE RECORDING MEDIUM STORING DETERMINATION PROGRAM, AND INFORMATION PROCESSING APPARATUS

(71) Applicant: Fujitsu Limited, Kawasaki-shi (JP)

(72) Inventor: Jun TAKAHASHI, Kawasaki (JP)

(73) Assignee: Fujitsu Limited, Kawasaki-shi (JP)

(21) Appl. No.: 18/752,899

(22) Filed: Jun. 25, 2024

Related U.S. Application Data
(63) Continuation of application No. PCT/JP2022/000758, filed on Jan. 12, 2022.

(51) Int. Cl. H04L 9/40; G06V 40/20; G06V 40/40; G06V 40/70; G10L 17/02; G10L 17/10; G10L 17/26; G10L 25/57

(52) U.S. Cl. CPC H04L 63/1483; G06V 40/20; G06V 40/40; G06V 40/70; G10L 17/02; G10L 17/10; G10L 17/26; G10L 25/57

(57) ABSTRACT

A method for determination causes a computer to execute a process including: obtaining, when first sensing data associated with an account of a participant in a remote conversation is received, feature information of a motion, voice, or a state or any combination of a motion, voice, or a state of the participant, the feature information being extracted from past second sensing data of the participant and having an extraction frequency lower than a first reference value; and making a determination related to spoofing based on a matching degree between the feature information extracted from the first sensing data and the feature information extracted from the second sensing data.

### CROSS-REFERENCE TO RELATED APPLICATION

This application is a continuation application of International Application PCT/JP2022/000758 filed on Jan. 12, 2022 and designated the U.S., the entire contents of which are incorporated herein by reference.

### FIELD

The embodiments discussed herein are related to a determination method, a determination program, and an information processing apparatus.

### BACKGROUND

In recent years, synthetic media using images and sounds generated and edited using artificial intelligence (AI) have been developed, and are expected to be utilized in various fields. On the other hand, synthetic media manipulated for improper purposes has become a social problem.

Japanese Patent No. 6901190 and Japanese Laid-open Patent Publication No. 2018-13529 are disclosed as related art.

### SUMMARY

According to an aspect of the embodiments, a method for determination causes a computer to execute a process including: obtaining, when first sensing data associated with an account of a participant in a remote conversation is received, feature information of a motion, voice, or a state or any combination of a motion, voice, or a state of the participant, the feature information being extracted from past second sensing data of the participant and having an extraction frequency lower than a first reference value; and making a determination related to spoofing based on a matching degree between the feature information extracted from the first sensing data and the feature information extracted from the second sensing data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a hardware configuration of a computer system as an example of a first embodiment;

FIG. 2 is a diagram exemplifying a functional configuration of the computer system as an example of the first embodiment;

FIG. 3 is a diagram exemplifying a plurality of databases included in a database group in the computer system as an example of the first embodiment;

FIG. 4 is a diagram exemplifying a first phrase corresponding text storage database, a first facial position information storage database, and a first skeletal position information storage database in the computer system as an example of the first embodiment;

FIG. 5 is a diagram for explaining a technique of matching behavior by an identity determination unit in the computer system as an example of the embodiment;

FIG. 6 is a flowchart for explaining a process of a first behavior detection unit in the computer system as an example of the first embodiment;

FIG. 7 is a flowchart for explaining a process of a first behavior extraction unit in the computer system as an example of the first embodiment;

FIG. 8 is a flowchart for explaining a process of a second behavior detection unit in the computer system as an example of the first embodiment;

FIG. 9 is a flowchart for explaining a process of a second behavior extraction unit in the computer system as an example of the first embodiment;

FIG. 10 is a flowchart for explaining a process of the identity determination unit in the computer system as an example of the first embodiment;

FIG. 11 is a flowchart for explaining a process of a notification unit in the computer system as an example of the first embodiment;

FIG. 12 is a diagram illustrating an example in which a method for determination of spoofing in the computer system as an example of the first embodiment is applied to a remote conference system;

FIG. 13 is a diagram exemplifying a functional configuration of a computer system as an example of a second embodiment;

FIG. 14 is a flowchart for explaining a process of an authority change unit in the computer system as an example of the second embodiment;

FIG. 15 is a diagram for exemplifying a functional configuration of a computer system as an example of a third embodiment;

FIG. 16 is a diagram for explaining a technique of determining a possibility of spoofing by an identity determination unit in the computer system as an example of the third embodiment;

FIG. 17 is a flowchart for explaining a process of a first behavior extraction unit in the computer system as an example of the third embodiment;

FIG. 18 is a flowchart for explaining a process of the identity determination unit in the computer system as an example of the third embodiment; and

FIG. 19 is a diagram exemplifying a functional configuration of a computer system as an example of a fourth embodiment.

### DESCRIPTION OF EMBODIMENTS

The synthetic media manipulated for improper purposes may be referred to as a deepfake. Furthermore, a fake image generated by the deepfake may be referred to as a deepfake image, and fake video generated by the deepfake may be referred to as deepfake video.

Due to technological evolution of AI and enhancement of computer resources, it has become technically possible to generate deepfake images and deepfake video that do not exist in reality, and fraud damage or the like caused by the deepfake images and deepfake video has become a social problem.

Additionally, the damage may further increase if the deepfake images and the deepfake video are fraudulently used for spoofing.

For example, in order to detect the deepfake video based on the synthetic media, there has been known a technique of comparing, during a remote conversation via the Internet, past and current behavior to issue a warning indicating that the participant is not the identical person if the behavior does not match.

However, according to such an existing technique of determining a deepfake, determination may not be made simply by comparing past and current behavior of a subject (participant).

For example, it is common to carry out training such that training data (=past behavior of the subject) matches data to be generated in an image generation model used for face conversion or a voice generation model used for voice conversion.

Thus, an attacker is enabled to reproduce behavior close to the subject if there is a large amount of training data, and for example, high-frequency behavior is easily reproduced. In view of the above, identity may not be confirmed simply by comparing the past and current behavior.

In one aspect, the embodiments aim to improve accuracy in detecting spoofing in a remote conversation.

Hereinafter, embodiments of the present determination method, determination program, and information processing apparatus will be described with reference to the drawings. Note that the embodiments described below are merely examples, and there is no intention to exclude application of various modifications and techniques not explicitly described in the embodiments. For example, the present embodiments may be modified in various manners (such as combining embodiments and individual modifications) and implemented in a range without departing from the scope thereof. Furthermore, each drawing is not intended to include only the components illustrated in the drawing, and may include other functions and the like.

### (I) Description of First Embodiment

### (A) Configuration

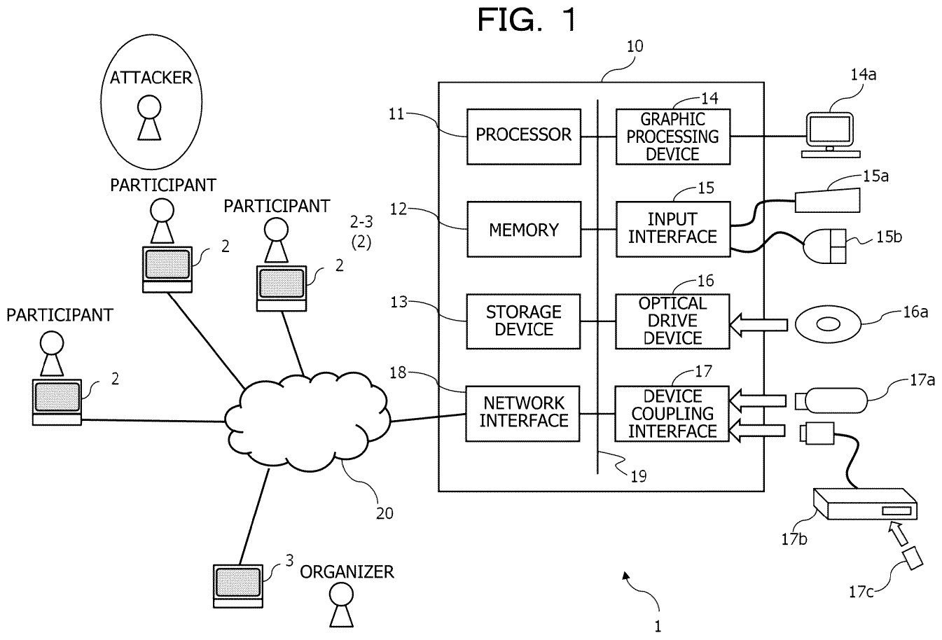

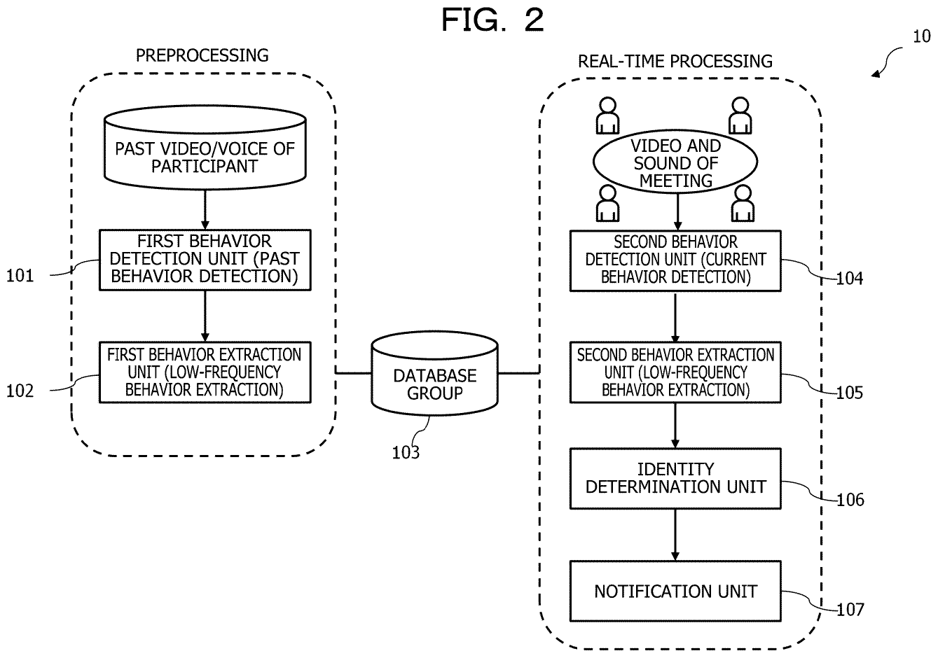

FIG. 1 is a diagram schematically illustrating a hardware configuration of a computer system 1 as an example of a first embodiment, and FIG. 2 is a diagram exemplifying a functional configuration thereof.

The computer system 1 exemplified in FIG. 1 includes an information processing apparatus 10, an organizer terminal 3, and a plurality of participant terminals 2. Those information processing apparatus 10, organizer terminal 3, and plurality of participant terminals 2 are communicably coupled to each other via a network 20.

The computer system 1 implements a remote conversation via the network 20 among users of the plurality of participant terminals 2. Note that, while three participant terminals 2 and one organizer terminal 3 are illustrated in FIG. 1 for convenience, it is not limited to this, and two or less or four or more participant terminals 2 may be included, or a plurality of the organizer terminals 3 may be included.

The remote conversation is made between two or more accounts among a plurality of accounts set to be enabled to participate in the remote conversation. Hereinafter, a participant in the remote conversation may be simply referred to as a participant. Each of the users of the participant terminals 2 corresponds to a participant. Hereinafter, a user him/herself of the participant terminal 2 may be referred to as a participant. The remote conversation may be, for example, an online meeting.

The present computer system 1 carries out a spoofing detection process for detecting, in the remote conversation held among the plurality of participant terminals 2, whether video transmitted from each of the participant terminals 2 is of the user of the participant terminal 2 or fake video (deepfake video) generated by an attacker using synthetic media.

The present computer system 1 assumes that, when a remote conversation is held among a plurality of participants, an attacker may impersonate a participant in the remote conversation (participant). The participant impersonated by the attacker may be referred to as a subject to be attacked.

Furthermore, it is assumed that the attacker may obtain information such as moving images and voice of the subject to be attacked in advance for spoofing.

Moreover, the attacker may impersonate the subject to be attacked using a known person generation tool (face conversion tool) or voice generation tool (voice conversion tool) based on the information regarding the subject to be attacked described above. For example, it is assumed that the attacker is enabled to participate in the conference with the same face or the same voice as the subject to be attacked.

The attacker impersonates the subject to be attacked, and holds a remote conversation with another receiver using an account (first account) of the subject to be attacked. When the attacker carries out spoofing using deepfake video, the subject to be attacked is actually the attacker. The attacker impersonating the subject to be attacked participates in the remote conversation with the account (first account) of the subject to be attacked.

Each of the plurality of participant terminals 2 is a computer, and has a configuration similar to each other. Each of the participant terminals 2 includes a processor, a memory, a display, a camera, a microphone, and a speaker (not illustrated).

Note that, in each of the participant terminals 2, the processor, the memory, and the display are similar to a processor 11, a memory 12, and a monitor 14a in the information processing apparatus 10 to be described later with reference to FIG. 1, respectively, and detailed descriptions thereof will be omitted.

With the participant terminal 2, the participant captures video of his/her face or the like using the camera, and transmits the video data to other participant terminals 2 and the information processing apparatus 10 in the remote conversation.

The video data transmitted from the participant terminal 2 is associated with the account of the participant who uses the participant terminal 2.

With each of the participant terminals 2, the participant obtains his/her voice using the microphone, and transmits the voice data to other participant terminals 2 and the information processing apparatus 10 in the remote conversation. With each of the participant terminals 2, the participant reproduces the voice data transmitted from other participant terminals 2 using the speaker.

The video data transmitted from the participant terminal 2 is associated with the account of the participant who uses the participant terminal 2.

The video of the participants transmitted from other participant terminals 2 is displayed on the display of each of the participant terminals 2. In the embodiment to be described below, an exemplary case where the video is a moving image (video image) will be described. In addition, hereinafter, the video data may be simply referred to as video. The video includes voice.

The organizer terminal 3 is a computer used by an organizer of the remote conversation (online meeting), and includes a processor, a memory, a display, a camera, a microphone, and a speaker (not illustrated).

Note that, in the organizer terminal 3, the processor, the memory, and the display are similar to the processor 11, the memory 12, and the monitor 14a in the information processing apparatus 10 to be described later with reference to FIG. 1, respectively, and detailed descriptions thereof will be omitted.

Presentation information (message) output from a notification unit 107 of the information processing apparatus 10 to be described later is displayed on the display of the organizer terminal 3.

The information processing apparatus 10 is a computer, and includes, as components, the processor 11, the memory 12, a storage device 13, a graphic processing device 14, an input interface 15, an optical drive device 16, a device coupling interface 17, and a network interface 18, for example, as illustrated in FIG. 1. Those components 11 to 18 are configured to be communicable with each other via a bus 19.

The processor (control unit) 11 controls the entire information processing apparatus 10. The processor 11 may be a multiprocessor. The processor 11 may be any one of a central processing unit (CPU), a micro processing unit (MPU), a digital signal processor (DSP), an application specific integrated circuit (ASIC), a programmable logic device (PLD), a field programmable gate array (FPGA), and a graphics processing unit (GPU), for example. Furthermore, the processor 11 may be a combination of two or more types of elements of the CPU, MPU, DSP, ASIC, PLD, FPGA, and GPU.

Then, the processor 11 executes a control program (determination program, OS program) for the information processing apparatus 10 to implement functions as a first behavior detection unit 101, a first behavior extraction unit 102, a second behavior detection unit 104, a second behavior extraction unit 105, an identity determination unit 106, and a notification unit 107 to be described later with reference to FIG. 2. The OS is an abbreviation for an operating system.

The programs in which processing contents to be executed by the information processing apparatus 10 are written may be recorded in various recording media. For example, the programs to be executed by the information processing apparatus 10 may be stored in the storage device 13. The processor 11 loads at least one of the programs in the storage device 13 into the memory 12, and executes the loaded program.

Furthermore, the programs to be executed by the information processing apparatus 10 (processor 11) may be recorded in a non-transitory portable recording medium such as an optical disk 16a, a memory device 17a, or a memory card 17c. The programs stored in the portable recording medium may be executed after being installed in the storage device 13 under the control of the processor 11, for example. Furthermore, the processor 11 may directly read a program from the portable recording medium and execute it.

The memory 12 is a storage memory including a read only memory (ROM) and a random access memory (RAM). The RAM of the memory 12 is used as a main storage device of the information processing apparatus 10. The RAM temporarily stores at least one of the programs to be executed by the processor 11. Furthermore, the memory 12 stores various kinds of data needed for processing by the processor 11.

The storage device 13 is a storage device such as a hard disk drive (HDD), a solid state drive (SSD), or a storage class memory (SCM), and stores various kinds of data. The storage device 13 is used as an auxiliary storage device of the information processing apparatus 10.

The storage device 13 stores the OS program, the control program, and various kinds of data. The control program includes the determination program. Furthermore, the storage device 13 may store information included in a database group 103. The database group 103 includes a plurality of databases.

Note that a semiconductor memory device, such as an SCM or a flash memory, may be used as the auxiliary storage device. Furthermore, redundant arrays of inexpensive disks (RAID) may be configured using a plurality of the storage devices 13.

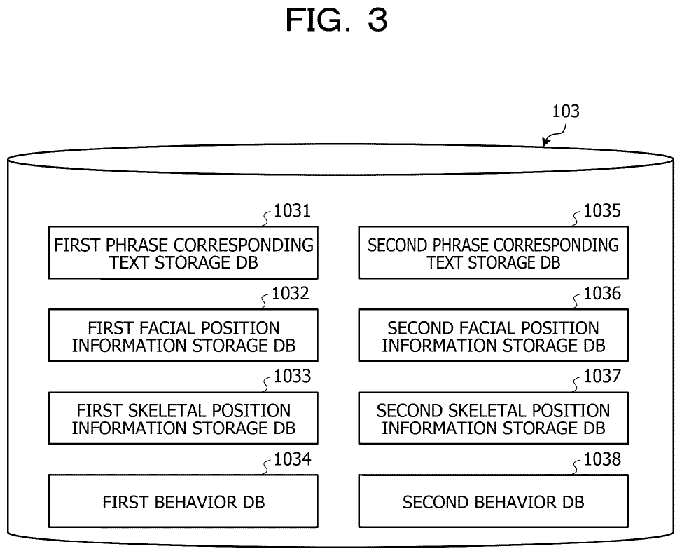

FIG. 3 is a diagram exemplifying a plurality of databases included in the database group 103 in the computer system 1 as an example of the first embodiment.

In the example illustrated in FIG. 3, the database group 103 includes a first phrase corresponding text storage database 1031, a first facial position information storage database 1032, a first skeletal position information storage database 1033, and a first behavior database 1034. Moreover, the database group 103 includes a second phrase corresponding text storage database 1035, a second facial position information storage database 1036, a second skeletal position information storage database 1037, and a second behavior database 1038. A database may be referred to as a DB. The DB is an abbreviation for a database.

Those first phrase corresponding text storage database 1031, first facial position information storage database 1032, first skeletal position information storage database 1033, first behavior database 1034, second phrase corresponding text storage database 1035, second facial position information storage database 1036, second skeletal position information storage database 1037, and second behavior database 1038 will be detailed later.

The memory 12 and the storage device 13 may store data or the like generated in the course of execution of each processing by the first behavior detection unit 101, the first behavior extraction unit 102, the second behavior detection unit 104, the second behavior extraction unit 105, the identity determination unit 106, and the notification unit 107.

The graphic processing device 14 is coupled to the monitor 14a. The graphic processing device 14 displays an image on a screen of the monitor 14a in accordance with an instruction from the processor 11. Examples of the monitor 14a include a display device using a cathode ray tube (CRT), a liquid crystal display device, and the like.

The input interface 15 is coupled to a keyboard 15a and a mouse 15b. The input interface 15 transmits signals sent from the keyboard 15a and the mouse 15b to the processor 11. Note that the mouse 15b is an exemplary pointing device, and another pointing device may be used. Examples of the another pointing device include a touch panel, a tablet, a touch pad, a track ball, and the like.

The optical drive device 16 reads data recorded in the optical disk 16a using laser light or the like. The optical disk 16a is a non-transitory portable recording medium in which data is recorded in a readable manner by reflection of light. Examples of the optical disk 16a include a digital versatile disc (DVD), a DVD-RAM, a compact disc read only memory (CD-ROM), a CD-recordable (R)/rewritable (RW), and the like.

The device coupling interface 17 is a communication interface for coupling a peripheral device to the information processing apparatus 10. For example, the memory device 17a and a memory reader/writer 17b may be coupled to the device coupling interface 17. The memory device 17a is a non-transitory recording medium equipped with a function of communicating with the device coupling interface 17, and is, for example, a universal serial bus (USB) memory. The memory reader/writer 17b writes data to the memory card 17c, or reads data from the memory card 17c. The memory card 17c is a card-type non-transitory recording medium.

The network interface 18 is coupled to the network 20. The network interface 18 transmits and receives data via the network 20. Each of the participant terminals 2 and the organizer terminal 3 are coupled to the network 20. Note that another information processing apparatus, communication device, and the like may be coupled to the network 20.

As illustrated in FIG. 2, the information processing apparatus 10 has functions as the first behavior detection unit 101, the first behavior extraction unit 102, the database group 103, the second behavior detection unit 104, the second behavior extraction unit 105, the identity determination unit 106, and the notification unit 107.

Among them, the first behavior detection unit 101 and the first behavior extraction unit 102 perform preprocessing using video (video data) of a remote conversation held in the past between two or more participants. Hereinafter, the video data may be simply referred to as video. The video data includes voice data. In addition, the voice data may be simply referred to as voice.

Furthermore, the second behavior detection unit 104, the second behavior extraction unit 105, the identity determination unit 106, and the notification unit 107 perform real-time processing using video of an ongoing remote conversation (during a remote conversation) between two or more participants.

The video of the past remote conversation held between the two or more participants is input to the first behavior detection unit 101. This video includes video of the participants. For example, the first behavior detection unit 101 may read the video data of the past remote conversation stored in the storage device 13 to obtain it.

The first behavior detection unit 101 detects a phrase from the voice uttered by the participant by, for example, voice recognition processing based on the video data of the remote conference held in the past. The phrase is a collection (phrase) of a plurality of words, and is a sequence of words representing a collective meaning. The phrase corresponds to feature information of a motion or voice of the participant.

In the voice recognition processing, for example, processing of extracting a feature amount is performed on the voice of the participant, and a phrase is detected from the voice of the participant based on the extracted feature amount. Note that the processing of detecting a phrase from the voice of the participant may be carried out using various known techniques, and descriptions thereof will be omitted.

The first behavior detection unit 101 registers information regarding the extracted phrase in the first phrase corresponding text storage database 1031.

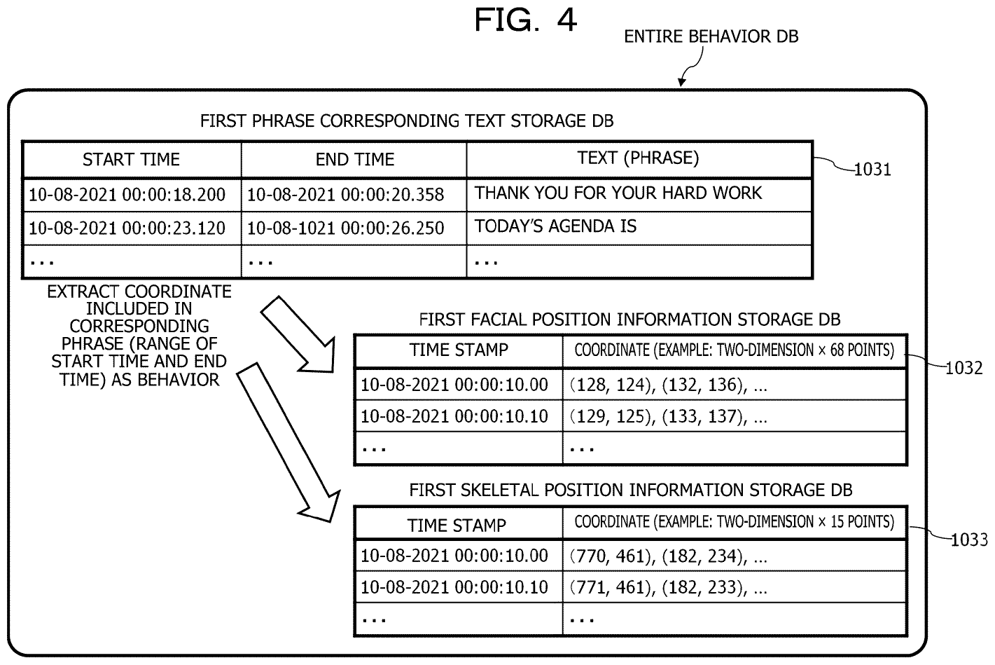

FIG. 4 is a diagram exemplifying the first phrase corresponding text storage database 1031, the first facial position information storage database 1032, and the first skeletal position information storage database 1033 in the computer system 1 as an example of the first embodiment.

In the first phrase corresponding text storage database 1031 exemplified in FIG. 4, start time, end time, and text (phrase) are associated with each other.

When the first behavior detection unit 101 detects that the participant utters some phrase in the video, it reads a time stamp from each of a head frame and an end frame of the period in which the phrase is detected in the video. The time stamp read from the head frame may be the start time, and the time stamp read from the end frame may be the end time.

The first behavior detection unit 101 causes the first phrase corresponding text storage database 1031 to store those start time and end time in association with the text representing the phrase. Note that a time period (time frame) specified by a combination of those start time and end time may be referred to as a phrase detection time period.

Furthermore, the first behavior detection unit 101 performs, for example, image recognition processing (face detection processing) on the video in the phrase detection time period to detect the face of the participant, and extracts behavior in the facial image. The behavior in the facial image corresponds to feature information of a motion or a state of the participant.

The first behavior detection unit 101 extracts positional information (coordinates) of a plurality of (e.g., 68) feature points (face landmarks) indicating outlines of eyes, a nose, a mouth, a face, and the like from the detected facial image, and performs matching of those face landmarks, thereby detecting the behavior in the facial image. The detection of the behavior in the facial image may be carried out using a known technique, and detailed descriptions thereof will be omitted.

The first behavior detection unit 101 causes the first facial position information storage database 1032 to record the coordinates of one or more feature points (face landmarks) in the video in association with the time stamp of the frame from which the feature point is extracted in the video.

The first facial position information storage database 1032 exemplified in FIG. 4 associates time stamps with the coordinates (coordinate group) of the 68 feature points in the facial image. By referring to the first facial position information storage database 1032, it becomes possible to detect, as behavior, a motion of the face (expression) in the video of the past remote conversation. In the first facial position information storage database 1032 exemplified in FIG. 4, the coordinate group of the feature points obtained every 0.1 seconds is registered as an entry.

Furthermore, the first behavior detection unit 101 performs, for example, image recognition processing (gesture detection processing) on the video in the phrase detection time period to detect the skeletal structure of the participant, and extracts positional information (coordinates) of the detected skeleton. The skeletal structure of the participant corresponds to feature information of a motion or a state of the participant.

The detection of the behavior in the skeletal structure may be carried out based on a known technique, and detailed descriptions thereof will be omitted.

The first behavior detection unit 101 causes the first skeletal position information storage database 1033 to record the coordinates of one or more feature points (skeletal position) in the video in association with the time stamp of the frame from which the feature point is extracted in the video.

The first skeletal position information storage database 1033 exemplified in FIG. 4 associates time stamps with the coordinates of 15 feature points (skeletal position) in the image. By referring to the first skeletal position information storage database 1033 and performing matching of a positional change of the feature point, it becomes possible to detect, as behavior, a motion (gesture) of the skeleton. In the first skeletal position information storage database 1033 exemplified in FIG. 4, the coordinate group of the feature points obtained every 0.1 seconds is registered as an entry.

Furthermore, the first behavior detection unit 101 may perform, for example, voice recognition processing (voice detection processing) on the video in the phrase detection time period to extract, as a feature amount, vocal tract characteristics and a pitch corresponding to the utterance or phrase uttered by the participant.

The first behavior detection unit 101 may detect the voice as the behavior by performing the matching of the positional change of the temporal change of one or more feature points (vocal tract characteristics, pitch) in the voice included in the video. The detection of the behavior in the voice may be carried out based on a known technique, and detailed descriptions thereof will be omitted.

The first behavior detection unit 101 detects the phrase and the behavior (e.g., motion of the face and motion of the skeletal position) in the phrase detection time period based on the entire video of the participants.

The first phrase corresponding text storage database 1031, the first facial position information storage database 1032, and the first skeletal position information storage database 1033 are created for each participant.

Furthermore, the first behavior detection unit 101 creates the first phrase corresponding text storage database 1031, the first facial position information storage database 1032, and the first skeletal position information storage database 1033 for all the participants.

The first phrase corresponding text storage database 1031, the first facial position information storage database 1032, and the first skeletal position information storage database 1033 for all the participants may be referred to as an entire behavior database. The entire behavior database may store video (voice) data of the participants and metadata that may be extracted from the video (voice) data.

The first behavior extraction unit 102 extracts behavior with a low appearance frequency for each of the participants based on the entire behavior database generated by the first behavior detection unit 101.

For a participant who is a target of determination (which may be referred to as a participant to be determined hereinafter), the first behavior extraction unit 102 selects one phrase (phrase to be determined) from a plurality of phrases registered in the first phrase corresponding text storage database 1031 of the participant to be determined, and reads the text included in the phrase to be determined.

Then, the first behavior extraction unit 102 extracts one or more words from the text of the phrase to be determined. The word extracted from the phrase to be determined may be referred to as an extracted word. Note that the processing of extracting the word (extracted word) from the text may be carried out using various known techniques, and descriptions thereof will be omitted.

The first behavior extraction unit 102 calculates an appearance frequency of the extracted word from all the words uttered by the participant to be determined in the entire video of the participant to be determined. The first behavior extraction unit 102 calculates the appearance frequency of each of all the extracted words included in the phrase to be determined in all the words.

Then, the first behavior extraction unit 102 calculates an average of a logarithmic sum of frequencies of a plurality of extracted words included in the phrase to be determined, thereby calculating an average value of the frequencies of the extracted words for the phrase to be determined. The average value of the frequencies of the extracted words included in the phrase to be determined may be referred to as a frequency average value of the phrase to be determined. The first behavior extraction unit 102 calculates the frequency in units of phrases.

When the calculated frequency average value of the phrase to be determined is smaller than a threshold TO (first reference value), the first behavior extraction unit 102 registers the phrase to be determined in the first behavior database 1034 as low-frequency behavior of the participant. The first behavior database 1034 stores feature information (behavior, phrase) of the participant having the appearance frequency (extraction frequency) lower than the threshold TO (first reference value).

A specific phrase uttered by the participant, which is detected based on the video data of the remote conference held in the past, may be referred to as a past phrase. Furthermore, among past phrases, the phrase to be determined having the frequency average value smaller than the threshold TO may be referred to as a past low-frequency phrase.

The first behavior database 1034 stores past low-frequency phrases for each participant. For example, the first behavior database 1034 may associate information for identifying the participant with the phrase to be determined, which has been determined as low-frequency behavior of the participant. Furthermore, the first behavior database 1034 may be provided for each participant so that the phrase to be determined, which has been determined as low-frequency behavior of the participant, may be stored in the first behavior database 1034, and an appropriate change may be made for implementation.

The first behavior extraction unit 102 sequentially switches the participant to be determined, and extracts behavior with a low appearance frequency for each participant to be determined. As a result, the first behavior extraction unit 102 extracts the behavior with a low appearance frequency for all the participants. The appearance frequency may be simply referred to as a frequency.

The first behavior extraction unit 102 may determine the frequency from a statistic of an ordinary person+a statistic of a participant.

For example, in a case of voice, greetings such as “good morning, everyone” and words frequently spoken by participants such as “how about oo?” may be set as high-frequency phrases.

Furthermore, phrases including a foreign word, a foreign name, a technical term, and the like may be set as low-frequency phrases.

For example, in the Japanese language, words and phrases including “zya”, “rya”, “bye”, “mye”, “dyo”, or “tyo” may be set as low-frequency phrases.

Furthermore, in the Japanese language, a phrase including consecutive terms of “nn” such as “2,000 yen bill”, a phrase including an unvoiced word of “u” or “i”, and a phrase including word of a nasal consonant (pronunciation that sounds like “nga” or “ngi”) may be set as low-frequency phrases.

Furthermore, in the English language, words and phrases including a sound of a phonetic symbol exemplified below may be set as low-frequency phrases.

### [Expression 1]

Examples of the phonetic symbol: /u [symbol] /, /3/, /i [symbol] /, /e [symbol] /,/θ/

Video of an ongoing remote conversation (being executed in real time) held among a plurality of participants is input to the second behavior detection unit 104. The video of the remote conversation (being executed in real time) held among the plurality of participants corresponds to first sensing data (video data) associated with the account of the participant in the remote conversation.

This video includes each participant video. The video of the remote conversation held among the participants is generated by, for example, a program for implementing a remote conversation among the participant terminals 2, and is transmitted to the information processing apparatus 10. The program for implementing the remote conversation may operate in each of the participant terminals 2, or may operate in the information processing apparatus 10 or another information processing apparatus having a server function.

The video of the remote conversation (being executed in real time) held among the plurality of participants is stored in, for example, a predetermined storage area of the memory 12 or the storage device 13 of the information processing apparatus 10. The second behavior detection unit 104 may read the stored video data of the remote conversation to obtain it.

The second behavior detection unit 104 detects a specific phrase from the voice of the participant by voice recognition processing based on the input video of the remote conversation in progress in real time (currently in progress).

The specific phrase uttered by the participant, which is detected from the video of the remote conversation in progress in real time (currently in progress) may be referred to as a current phrase.

The second behavior detection unit 104 detects the current phrase from the voice of the participant using a technique similar to that of the first behavior detection unit 101.

The second behavior detection unit 104 registers information regarding the extracted phrase in the second phrase corresponding text storage database 1035. The second phrase corresponding text storage database 1035 has a configuration similar to that of the first phrase corresponding text storage database 1031, and descriptions thereof will be omitted.

Furthermore, the second behavior detection unit 104 performs, for example, image recognition processing (face detection processing) on the video in the phrase detection time period in the video of the remote conversation in progress in real time (currently in progress) in a similar manner to the first behavior detection unit 101. As a result, the second behavior detection unit 104 detects the face of the participant in the video of the remote conversation in progress in real time (currently in progress), and extracts positional information (coordinates) of feature points (face landmarks) from the detected facial image.

The second behavior detection unit 104 causes the second facial position information storage database 1036 to record the coordinates of one or more feature points (face landmarks) in the video of the remote conversation in progress in real time (currently in progress) in association with the time stamp of the frame from which the feature point is extracted in the video.

The second facial position information storage database 1036 has a configuration similar to that of the first facial position information storage database 1032 exemplified in FIG. 4, and descriptions thereof will be omitted.

By referring to the second facial position information storage database 1036, it becomes possible to detect, as behavior, a motion of the face (expression) in the video of the remote conversation in progress in real time (currently in progress).

Furthermore, the second behavior extraction unit 105 performs image recognition processing (gesture detection processing) on the video in the phrase detection time period in the video of the remote conversation in progress in real time (currently in progress) in a similar manner to the first behavior detection unit 101. As a result, the second behavior extraction unit 105 detects a skeletal structure of the participant in the video of the remote conversation in progress in real time (currently in progress), and extracts positional information (coordinates) of the detected skeleton.

The second behavior extraction unit 105 causes the second skeletal position information storage database 1037 to record the coordinates of one or more feature points (skeletal position) in the video in association with the time stamp of the frame from which the feature point is extracted in the video.

The second skeletal position information storage database 1037 has a configuration similar to that of the first skeletal position information storage database 1033 exemplified in FIG. 4, and descriptions thereof will be omitted.

By referring to the second skeletal position information storage database 1037, it becomes possible to detect, as behavior, a motion (gesture) of the skeleton in the video of the remote conversation in progress in real time (currently in progress).

The second behavior extraction unit 105 extracts behavior with a low appearance frequency from among the phrases (current phrases) detected by the second behavior detection unit 104 in the remote conversation in progress in real time (currently in progress).

The second behavior extraction unit 105 checks whether a phrase (past low-frequency phrase) that matches the phrase detected in the remote conversation in progress in real time (currently in progress) is registered in the first behavior database 1034 as a low-frequency phrase of the same participant. As a result of this checking, when the same phrase as the current phrase is registered in the first behavior database 1034, a pair of those current phrase and past low-frequency phrase is generated.

When the second behavior extraction unit 105 receives the video (first sensing data) of the ongoing remote conversation (being executed in real time) held among the plurality of participants, it obtains the feature information (behavior, phrase) of the participant, which is extracted from the video (second sensing data) of the remote conversation held among the participants in the past and has the appearance frequency (extraction frequency) lower than the threshold TO (first reference value).

The pair of the current phrase and the past low-frequency phrase generated by the second behavior extraction unit 105 is generated on the assumption that utterers of the respective phrases have the same account.

It is preferable that the second behavior extraction unit 105 generates a plurality of (N) pairs of the current phrase and the past low-frequency phrase.

Information regarding the pair of the current phrase and the past low-frequency phrase generated in this manner may be stored in, for example, a predetermined area of the memory 12 or the storage device 13.

The identity determination unit 106 determines whether the participant who has uttered the current phrase is the same as the participant who has uttered the past low-frequency phrase based on the pair of the current phrase and the past low-frequency phrase generated by the second behavior extraction unit 105 using the same account.

The identity determination unit 106 obtains each of the behavior for the current phrase and the behavior for the past low-frequency phrase for the pair of the current phrase and the past low-frequency phrase generated by the second behavior extraction unit 105. Here, the behavior for the current phrase may be referred to as current behavior. In addition, the behavior for the past low-frequency phrase may be referred to as past behavior.

Hereinafter, an exemplary case where the behavior for the current phrase and the behavior for the past low-frequency phrase are voice signals corresponding to the phrases will be described.

The identity determination unit 106 obtains the past behavior (voice signal corresponding to the phrase) from the video data of the remote conversation made in the past, and obtains the current behavior (voice signal corresponding to the current phrase) from the video data of the remote conversation in progress in real time (currently in progress).

The identity determination unit 106 performs matching between the current behavior (voice signal corresponding to the current phrase) and the past behavior (voice signal corresponding to the past low-frequency phrase), which use the same account.

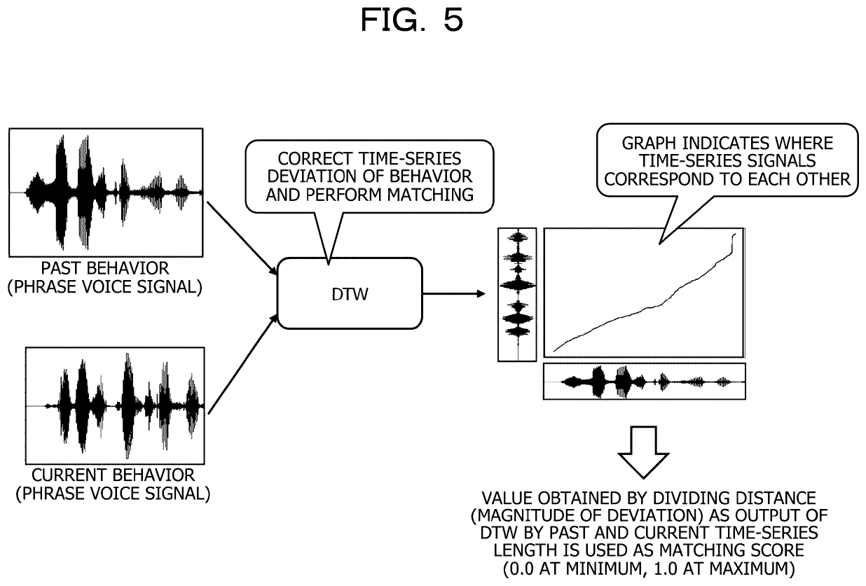

FIG. 5 is a diagram for explaining a technique of matching the behavior by the identity determination unit 106 in the computer system 1 as an example of the embodiment.

FIG. 5 illustrates an exemplary case where the identity determination unit 106 corrects a time-series deviation of the behavior to perform matching using dynamic time warping (DTW).

In FIG. 5, the past behavior (voice signal of the phrase) and the current behavior (voice signal of the phrase) are input to the DTW.

Furthermore, as an output of the DTW, a graph is illustrated in which the vertical axis represents the past behavior (voice signal of the phrase) and the horizontal axis represents the current behavior (voice signal of the phrase). This graph indicates where time-series signals correspond to each other.

In the technique using the DTW, a value obtained by dividing a distance (magnitude of a deviation), which is the output of the DTW, by past and current time-series lengths may be used as a matching score. The minimum value of the matching score may be set to 0.0, and the maximum value may be set to 1.0. The matching score in the case complete matching (matching) is 0, and the matching score in the case of no matching (non-matching) is 1.

The identity determination unit 106 obtains matching scores D1 to Dn between the current behavior (voice signal corresponding to the current phrase) and the past behavior (voice signal corresponding to the past low-frequency phrase) for each of the plurality of (N) pairs of the current phrase and the past low-frequency phrase generated by the second behavior extraction unit 105.

For example, the identity determination unit 106 calculates a matching degree (matching score) for each of the plurality of (N) pairs of the phrase (feature information) extracted from the video (first sensing data) of the ongoing remote conversation (being executed in real time) held among the participants and the low-frequency phrase (feature information) extracted from the video (second sensing data) of the remote conversation held among the participants in the past.

Then, the identity determination unit 106 compares each of the obtained matching scores D1 to Dn with a predetermined threshold T1 (second reference value), and obtains the number of matching scores smaller than the threshold T1, for example, the number of pairs of the current phrase and the past low-frequency phrase.

The identity determination unit 106 compares the number of pairs of the current phrase and the past low-frequency phrase smaller than the threshold T1 with a predetermined threshold T2 (third reference value).

When the number of pairs of the current phrase and the past low-frequency phrase having the matching score smaller than the threshold T1 is equal to or larger than the threshold T2, the identity determination unit 106 determines that the participant who has uttered the current phrase is the same as the participant who has uttered the past low-frequency phrase for the pair of the current phrase and the past low-frequency phrase.

On the other hand, when the number of pairs of the current phrase and the past low-frequency phrase having the matching score smaller than the threshold T1 is smaller than the threshold T2, the identity determination unit 106 determines that the participant who has uttered the current phrase is not the same as the participant who has uttered the past low-frequency phrase for the pair of the current phrase and the past low-frequency phrase.

The identity determination unit 106 determines that spoofing has occurred when the number of pairs having the matching degree (matching score) lower than the threshold T1 (second reference value) is smaller than the threshold T2 (third reference value).

The identity determination unit 106 determines, as an impersonation participant, the participant who has uttered the current phrase and has determined not to be the same as the participant who has uttered the past low-frequency phrase using the same account.

The identity determination unit 106 makes a determination related to spoofing based on the matching degree (matching score) between the phrase (feature information) extracted from the video (first sensing data) of the ongoing remote conversation (being executed in real time) held among the plurality of participants and the phrase (feature information) extracted from the video (second sensing data) of the remote conversation held among the participants in the past.

The notification unit 107 makes notification to the organizer when the identity determination unit 106 determines that the participant who has uttered the current phrase is not the same as the participant who has uttered the past low-frequency phrase for the pair of the current phrase and the past low-frequency phrase using the same account.

The notification unit 107 may transmit, to the organizer terminal 3, a message (notification information) indicating that “the participant may be impersonated”.

Furthermore, the notification unit 107 may notify the organizer terminal 3 of information (e.g., account information, notification information) for identifying the impersonation participant determined by the identity determination unit 106 together with the message.

For example, the notification unit 107 displays, on the display of the organizer terminal 3, information (message, notification information) indicating that “the participant may be impersonated”.

With the organizer terminal 3, for example, the organizer may remove the participant determined as an impersonation participant from the remote conversation. Furthermore, the organizer may ask some sort of question (e.g., question that may be correctly answered only by the identical participant) to the participant determined as an impersonation participant to confirm whether the determination made by the identity determination unit 106 is correct.

### (B) Operation

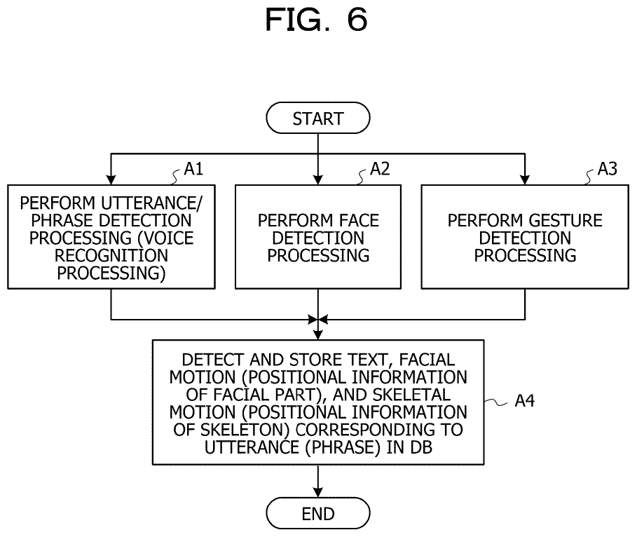

A process of the first behavior detection unit 101 in the computer system 1 as an example of the first embodiment configured as described above will be described with reference to a flowchart (steps A1 to A4) illustrated in FIG. 6.

The video data of the remote conference of the participant held in the past is input to the first behavior detection unit 101.

The first behavior detection unit 101 detects a phrase from the voice uttered by the participant by voice recognition processing based on the video data of the remote conference held in the past (step A1).

Furthermore, the first behavior detection unit 101 detects the face of the participant by performing image recognition processing based on the video data of the remote conference held in the past (step A2). Furthermore, the first behavior detection unit 101 extracts positional information (coordinates) of feature points (face landmarks) from the detected facial image.

Moreover, the first behavior detection unit 101 performs gesture detection processing by performing image recognition processing based on the video data of the remote conference held in the past (step A3). Furthermore, the first behavior detection unit 101 detects the skeletal structure of the detected participant, and extracts positional information (coordinates) of the detected skeleton.

The processing of steps A1 to A3 described above may be performed in parallel, or the processing of steps A2 and A3 may be performed after the processing of step A1 is performed, for example, which indicates that an appropriate change may be made for execution.

Thereafter, in step A4, the first behavior detection unit 101 causes the first phrase corresponding text storage database 1031 to store the start time and the end time of the phrase in the video data of the remote conference held in the past in association with the text representing the phrase.

Furthermore, the first behavior detection unit 101 causes the first facial position information storage database 1032 to record the positional information (coordinates of the face landmarks) of the facial parts (feature points) of the participant in the video in association with a time stamp.

Moreover, the first behavior detection unit 101 causes the first skeletal position information storage database 1033 to record the coordinates (positional information of the skeleton) of one or more skeletal positions (feature points) in the video in association with a time stamp. Thereafter, the process is terminated.

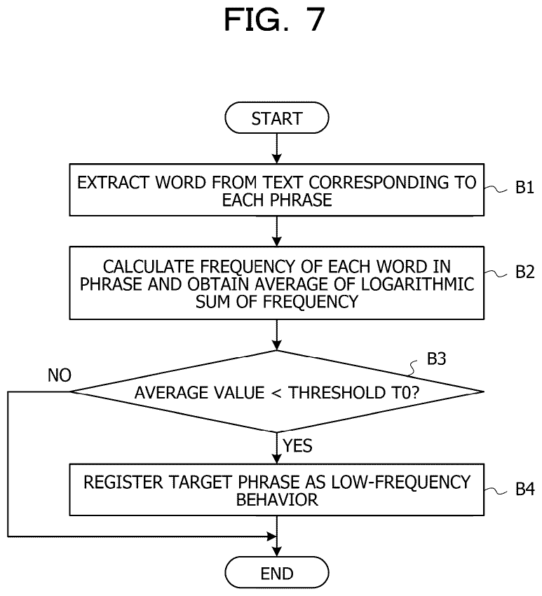

Next, a process of the first behavior extraction unit 102 in the computer system 1 as an example of the first embodiment will be described with reference to a flowchart (steps B1 to B4) illustrated in FIG. 7.

The entire behavior database for all the participants generated by the first behavior detection unit 101 is input to the first behavior extraction unit 102.

In step B1, the first behavior extraction unit 102 obtains the text corresponding to the phrase (phrase to be determined) from the first phrase corresponding text storage database 1031.

In step B2, the first behavior extraction unit 102 calculates an appearance frequency of the extracted word from all the words uttered by the participant to be determined in the entire video of the participant to be determined. The first behavior extraction unit 102 calculates the appearance frequency of each of all the extracted words included in the phrase to be determined in all the words.

The first behavior extraction unit 102 calculates an average of a logarithmic sum of frequencies of a plurality of extracted words included in the phrase to be determined, thereby calculating an average value of the frequencies of the extracted words for the phrase to be determined.

In step B3, the first behavior extraction unit 102 checks whether the calculated frequency average value of the phrase to be determined is smaller than the threshold TO. As a result of the checking, if the calculated frequency average value of the phrase to be determined is smaller than the threshold TO (see YES route of step B3), the process proceeds to step B4.

In step B4, the first behavior extraction unit 102 registers the phrase to be determined in the first behavior database 1034 as low-frequency behavior of the participant. Thereafter, the process is terminated.

Furthermore, as a result of the checking in step B3, if the calculated frequency average value of the phrase to be determined is equal to or larger than the threshold TO (see NO route of step B3), step B4 is skipped, and the process is terminated.

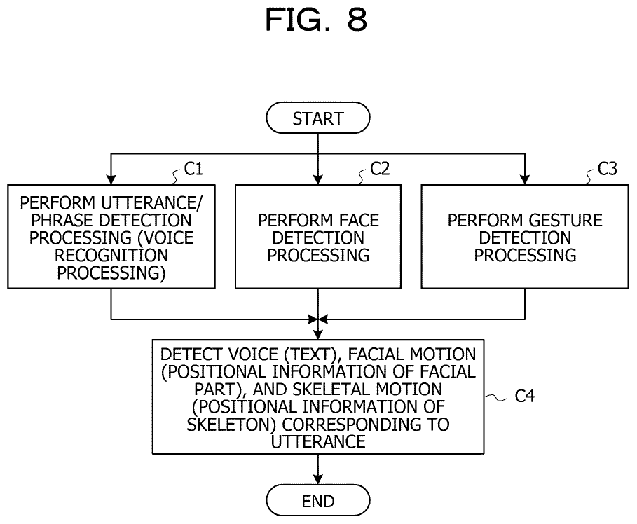

Next, a process of the second behavior detection unit 104 in the computer system 1 as an example of the first embodiment will be described with reference to a flowchart (steps C1 to C4) illustrated in FIG. 8.

Video of an ongoing remote conversation (being executed in real time) held among a plurality of participants is input to the second behavior detection unit 104.

The second behavior detection unit 104 detects a phrase from the voice uttered by the participant by voice recognition processing based on the video data of the ongoing remote conversation held in real time among the plurality of participants (step C1).

Furthermore, the second behavior detection unit 104 detects the face of the participant by performing image recognition processing based on the video data of the ongoing remote conversation held in real time among the plurality of participants (step C2). Furthermore, the second behavior detection unit 104 extracts positional information (coordinates) of feature points (face landmarks) from the detected facial image based on the video data of the remote conference held in the past.

Moreover, the second behavior detection unit 104 performs gesture detection processing by performing image recognition processing based on the video data of the ongoing remote conversation held in real time among the plurality of participants (step C3). Furthermore, the second behavior detection unit 104 detects the skeletal structure of the detected participant, and extracts positional information (coordinates) of the detected skeleton.

The processing of steps C1 to C3 described above may be performed in parallel, or the processing of steps C2 and C3 may be performed after the processing of step C1 is performed, for example, which indicates that an appropriate change may be made for execution.

Thereafter, in step C4, the second behavior detection unit 104 causes the second phrase corresponding text storage database 1035 to store the start time and the end time of the phrase in the video data of the ongoing remote conversation held in real time among the plurality of participants in association with the text representing the phrase.

Furthermore, the second behavior detection unit 104 causes the second facial position information storage database 1036 to record the positional information (coordinates of the face landmarks) of the facial parts of the participant in the video in association with a time stamp.

Moreover, the second behavior detection unit 104 causes the second skeletal position information storage database 1037 to record the coordinates (positional information of the skeleton) of one or more skeletal positions in the video in association with a time stamp. Thereafter, the process is terminated.

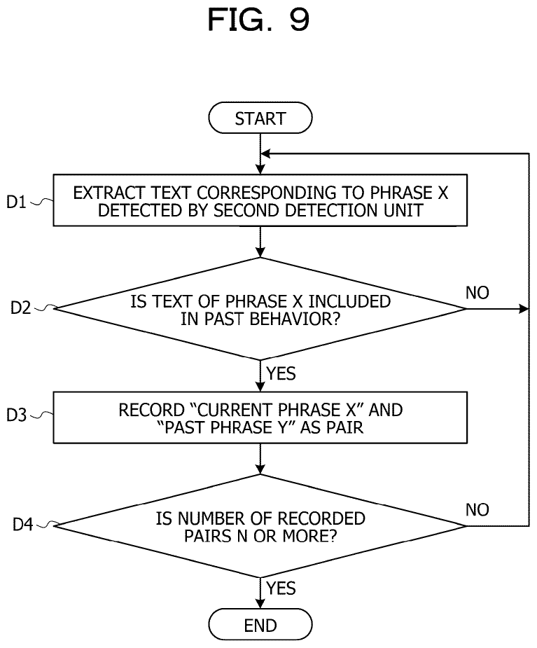

Next, a process of the second behavior extraction unit 105 in the computer system 1 as an example of the first embodiment will be described with reference to a flowchart (steps D1 to D4) illustrated in FIG. 9.

In step D1, the second behavior detection unit 104 obtains (extracts), from the second phrase corresponding text storage database 1035, the text corresponding to the phrase detected by the second behavior detection unit 104. The phrase detected by the second behavior detection unit 104 from the video data of the ongoing remote conversation held in real time among the plurality of participants may be referred to as a phrase X.

In step D2, the second behavior extraction unit 105 checks whether the phrase (past low-frequency phrase) that matches the phrase X detected in step D1 is registered in the first behavior database 1034 as a low-frequency phrase of the same participant (same account).

As a result of the checking, if the phrase (past low-frequency phrase) that matches the phrase X is not registered in the first behavior database 1034 as a low-frequency phrase of the same participant (same account) (see NO route of step D2), the process returns to step D1.

If the phrase (past low-frequency phrase) that matches the phrase X is registered in the first behavior database 1034 as a low-frequency phrase of the same participant (same account) (see YES route of step D2), the process proceeds to step D3. Note that the same low-frequency phrase of the same participant (same account) registered in the first behavior database 1034 may be referred to as a past phrase Y.

In step D3, the second behavior extraction unit 105 causes the phrase X and the phrase Y to be stored as a pair in, for example, a predetermined area of the memory 12 or the storage device 13.

In step D4, the second behavior extraction unit 105 checks whether the number of pairs of the phrase X and the phrase Y stored in the predetermined area of the memory 12 or the storage device 13 is equal to or larger than a predetermined number (N).

As a result of the checking, if the number of pairs of the phrase X and the phrase Y is smaller than the predetermined number (N) (see NO route of step D4), the process returns to step D1.

On the other hand, if the number of pairs of the phrase X and the phrase Y is equal to or larger than the predetermined number (N) (see YES route of step D4), the process is terminated.

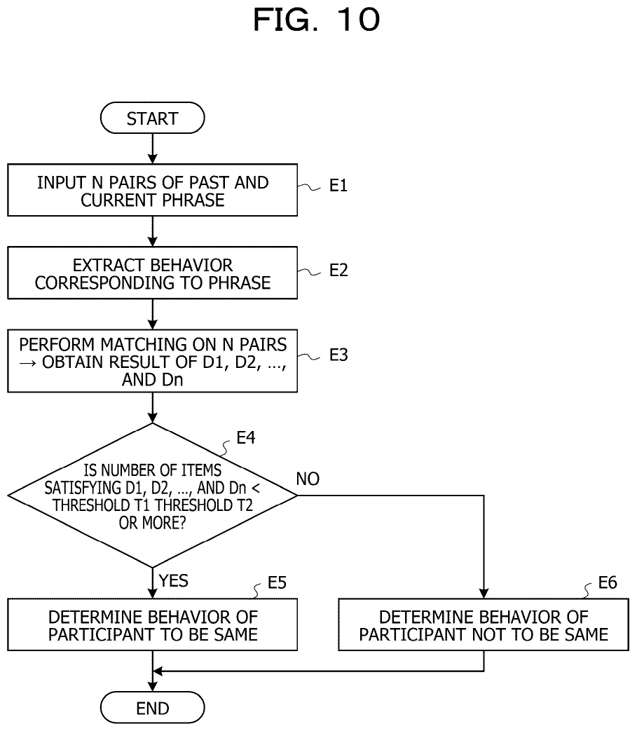

Next, a process of the identity determination unit 106 in the computer system 1 as an example of the first embodiment will be described with reference to a flowchart (steps E1 to E6) illustrated in FIG. 10.

In step E1, N pairs of the current phrase and the past low-frequency phrase generated by the second behavior extraction unit 105 using the same account are input to the identity determination unit 106.

In step E2, the identity determination unit 106 obtains each of the behavior for the current phrase and the behavior for the past low-frequency phrase.

In step E3, the identity determination unit 106 obtains matching scores D1 to Dn between the current behavior (voice signal corresponding to the current phrase) and the past behavior (voice signal corresponding to the past low-frequency phrase) for each of the plurality of (N) pairs of the current phrase and the past low-frequency phrase.

In step E4, the identity determination unit 106 compares each of the obtained matching scores D1 to Dn with the predetermined threshold T1, and checks whether the number of matching scores smaller than the threshold T1 is equal to or larger than the threshold T2. For example, the threshold T1=0.25 may be set, and the threshold T2=2 may be set.

As a result of the checking, if the number of matching scores smaller than the threshold T1 is equal to or larger than the threshold T2 (see YES route of step E4), the process proceeds to step E5.

In step E5, the identity determination unit 106 determines that the participant who has uttered the current phrase is the same as the participant who has uttered the past low-frequency phrase for the pair of the current phrase and the past low-frequency phrase. Thereafter, the process is terminated.

On the other hand, if the number of matching scores smaller than the threshold T1 is smaller than the threshold T2 (see NO route of step E4), the process proceeds to step E6.

In step E6, the identity determination unit 106 determines that the participant who has uttered the current phrase is not the same as the participant who has uttered the past low-frequency phrase for the pair of the current phrase and the past low-frequency phrase. Thereafter, the process is terminated.

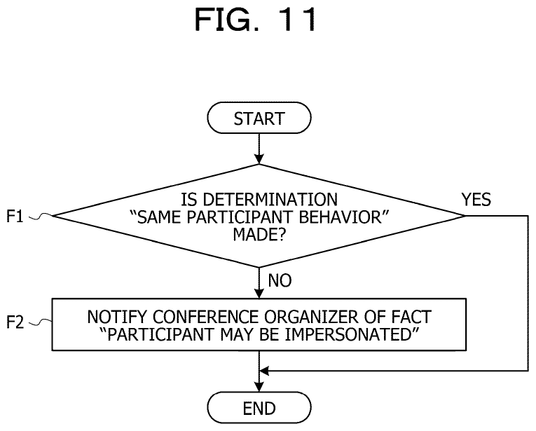

Next, a process of the notification unit 107 in the computer system 1 as an example of the first embodiment will be described with reference to a flowchart (steps F1 and F2) illustrated in FIG. 11.

In step F1, the notification unit 107 checks whether the identity determination unit 106 determines that the participant who has uttered the current phrase is the same as the participant who has uttered the past low-frequency phrase for the pair of the current phrase and the past low-frequency phrase using the same account.

If the identity determination unit 106 does not determine that the participant who has uttered the current phrase is the same as the participant who has uttered the past low-frequency phrase (see NO route of step F1), the process proceeds to step F2.

In step F2, the notification unit 107 notifies the organizer of the fact that “the participant may be impersonated”. Thereafter, the process is terminated.

Furthermore, if the identity determination unit 106 determines that the participant who has uttered the current phrase is the same as the participant who has uttered the past low-frequency phrase (see YES route of step F1) as a result of the checking in step F1, the process is directly terminated.

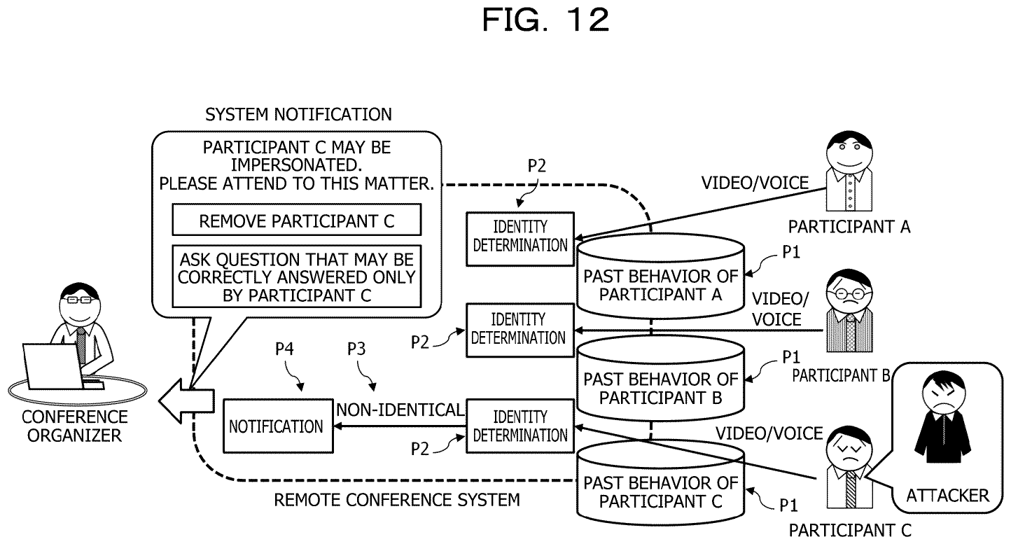

Next, an example in which a method for determination of spoofing in the computer system 1 as an example of the first embodiment is applied to a remote conference system is illustrated in FIG. 12.

In this example illustrated in FIG. 12, an exemplary case where three participants A, B, and C participate in a remote conference held by the organizer is illustrated.

First, preprocessing by the first behavior detection unit 101 and the first behavior extraction unit 102 is performed based on video data of a remote conference held among the participants A, B, and C in the past. Note that the video data of the remote conference held among the participants A, B, and C in the past is not necessarily video data of a remote conference in which all of the participants A, B, and C have participated. Video data of a plurality of remote conferences in which the participants A, B, and C have individually participated may be used.

The first behavior detection unit 101 detects a phrase for each of the participants A, B, and C, and obtains text corresponding to the detected phrase based on the video data when the participants A, B, and C have participated in the past remote conference.

Furthermore, the first behavior detection unit 101 extracts feature points (face landmarks, skeletal position information) from a facial image and a skeletal structure of each of the participants A, B, and C based on the video data when the participants A, B, and C have participated in the past remote conference, and generates an entire behavior database.

Then, the first behavior extraction unit 102 extracts behavior with a low appearance frequency for each of the participants based on the entire behavior database generated by the first behavior detection unit 101 (see the reference sign P1 in FIG. 12).

Next, real-time processing by the second behavior detection unit 104, the second behavior extraction unit 105, the identity determination unit 106, and the notification unit 107 is performed based on the ongoing remote conversation held in real time among the plurality of participants A, B, and C.

The second behavior detection unit 104 detects a phrase for each of the participants A, B, and C, and obtains text corresponding to the detected phrase based on the video data at the time of participating in the ongoing remote conference held in real time among the participants A, B, and C.

Furthermore, the second behavior detection unit 104 extracts feature points (face landmarks, skeletal position information) from the facial image and the skeletal structure of each of the participants A, B, and C based on the video data at the time of participating in the ongoing remote conference held in real time among the participants A, B, and C, and generates the entire behavior database.

The second behavior extraction unit 105 generates a plurality of pairs of the past low-frequency phrase and the current phrase detected by the second behavior detection unit 104 for each of the participants A, B, and C.

Thereafter, the identity determination unit 106 determines, for each of the participants A, B, and C, whether the participant who has uttered the current phrase is the same as the participant who has uttered the past low-frequency phrase based on the pairs of the current phrase and the past low-frequency phrase generated by the second behavior extraction unit 105 (see the reference sign P2).

In the example illustrated in FIG. 12, the participant C is a subject to be attacked, and video to be transmitted associated with the account of this participant C is fake video generated by the attacker by a deepfake.

For example, voice synthesis for generating spoofing data from zero has a characteristic that, while it creates a generation model from zero using a large amount of data, quality deteriorates when attempting to generate data with a low frequency.

Furthermore, for example, in voice quality conversion for generating spoofing data using a standard model, a generation model (to be precise, difference model of the standard model) is created using the standard model created in advance and a small amount of data. When low-frequency behavior of a target person is generated using such a sound quality conversion technique, there is a characteristic that the likelihood of the subject person (behavior unique to the subject person) decreases while the quality is less likely to deteriorate. Therefore, reproducibility of the low-frequency phrase decreases in the fake video.

When the number of pairs of the current phrase and the past low-frequency phrase having the matching score smaller than the threshold T1 is smaller than the threshold T2, the identity determination unit 106 determines that the participant who has uttered the current phrase is not the same as the participant who has uttered the past low-frequency phrase for the pair of the current phrase and the past low-frequency phrase (see the reference sign P3).

When the identity determination unit 106 determines that the participant who has uttered the current phrase is not the same as the participant who has uttered the past low-frequency phrase, the notification unit 107 notifies the conference organizer (see the reference sign P4).

### (C) Effects

As described above, according to the computer system 1 as an example of the first embodiment, the first behavior extraction unit 102 extracts a behavior with a low appearance frequency for the participant based on the video data of the remote conversation held in the past. The first behavior extraction unit 102 registers the phrase to be determined in the first behavior database 1034 as low-frequency behavior (feature information) of the participant.

Furthermore, the second behavior extraction unit 105 generates a plurality of (N) pairs of the current phrase and the past low-frequency phrase.

Then, the identity determination unit 106 obtains matching scores D1 to Dn between the current behavior (voice signal corresponding to the current phrase) and the past behavior (voice signal corresponding to the past low-frequency phrase) for each of the plurality of (N) pairs of the current phrase and the past low-frequency phrase generated by the second behavior extraction unit 105.

When the number of pairs of the current phrase and the past low-frequency phrase is smaller than the threshold T2, the identity determination unit 106 determines that the participant who has uttered the current phrase is not the same as the participant who has uttered the past low-frequency phrase for the pair of the current phrase and the past low-frequency phrase.

As a result, it becomes possible to easily determine whether the participant in the remote conversation is impersonated by an attacker.

### (II) Description of Second Embodiment

### (A) Configuration

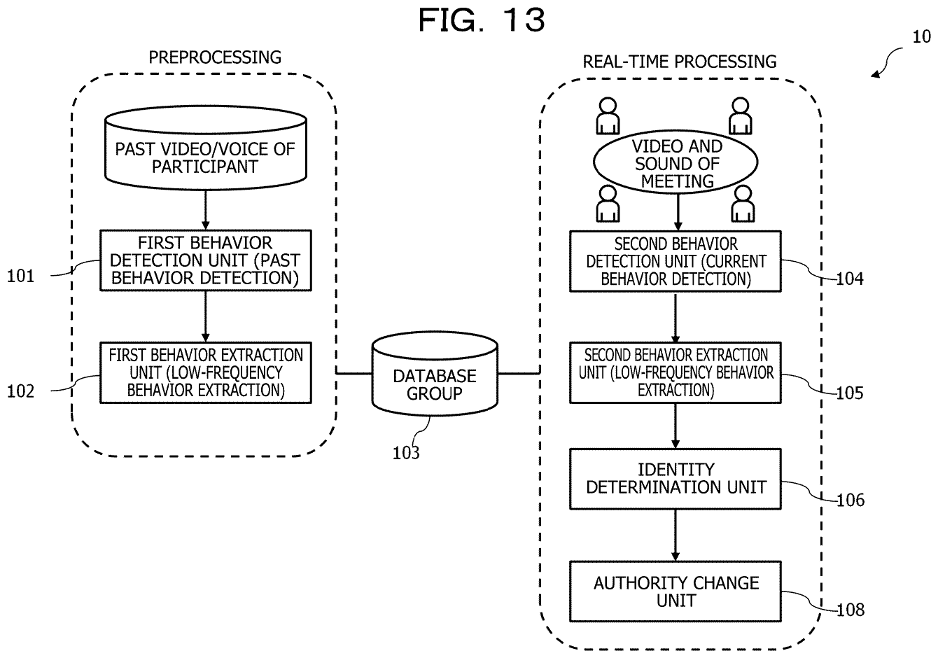

FIG. 13 is a diagram exemplifying a functional configuration of a computer system 1 as an example of a second embodiment.

As illustrated in this FIG. 13, the computer system 1 according to the second embodiment includes an authority change unit 108 in place of the notification unit 107 in the computer system 1 according to the first embodiment, and other parts are configured in a similar manner to the computer system 1 according to the first embodiment.

In the present second embodiment, a processor 11 executes a determination program to implement functions as a first behavior detection unit 101, a first behavior extraction unit 102, a second behavior detection unit 104, a second behavior extraction unit 105, an identity determination unit 106, and the authority change unit 108.

Reference signs same as the aforementioned reference signs denote similar components in the drawing, and thus descriptions thereof will be omitted.

The authority change unit 108 has a function of changing authority of the participant (account) to participate in the remote conversation. For example, the authority change unit 108 revokes the participation authority for the participant to participate in the remote conversation, and causes the participant to leave the remote conversation.

When the identity determination unit 106 determines that the participant who has uttered the current phrase is not the same as the participant who has uttered the past low-frequency phrase for the pair of the current phrase and the past low-frequency phrase using the same account, the authority change unit 108 revokes the authority of the participant (account) to participate in the remote conversation.

Note that, in order to cause the participant who has been stripped of the authority to participate in the remote conversation to participate in the remote conversation again, for example, some kind of penalty may be imposed on the participant, such as that the participant is not allowed to participate in the remote conversation again until a predetermined time (e.g., 30 minutes) has elapsed after the revoking of the authority to participate in the remote conversation.

### (B) Operation

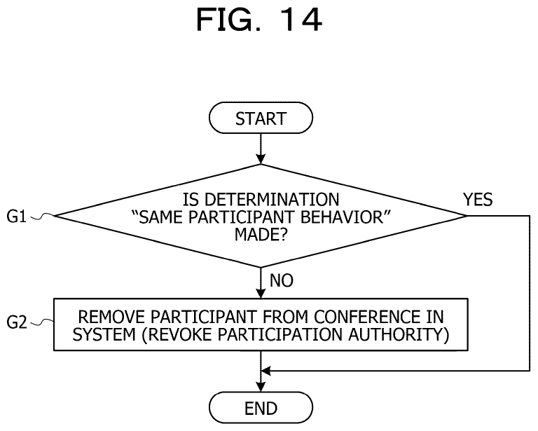

A process of the authority change unit 108 in the computer system 1 as an example of the second embodiment will be described with reference to a flowchart (steps G1 and G2) illustrated in FIG. 14.

This process is started when the identity determination unit 106 determines whether or not the participant who has uttered the current phrase is the same as the participant who has uttered the past low-frequency phrase.

In step G1, the authority change unit 108 checks whether the identity determination unit 106 determines that the participant who has uttered the current phrase is the same as the participant who has uttered the past low-frequency phrase.

As a result of the checking, if the identity determination unit 106 determines that the participant who has uttered the current phrase is not the same as the participant who has uttered the past low-frequency phrase (see NO route of step G1), the process proceeds to step G2.

In step G2, the authority change unit 108 revokes the authority of the participant (account) to participate in the remote conversation, and causes the participant to leave the remote conversation. Thereafter, the process is terminated.

Furthermore, if the identity determination unit 106 determines that the participant who has uttered the current phrase is the same as the participant who has uttered the past low-frequency phrase (see YES route of step G1) as a result of the checking, the process is directly terminated.

### (C) Effects

As described above, according to the computer system 1 as an example of the second embodiment, action effects similar to those of the first embodiment described above may be obtained.

Furthermore, when the identity determination unit 106 determines that the participant who has uttered the current phrase is not the same as the participant who has uttered the past low-frequency phrase, the authority change unit 108 revokes the authority of the participant (account) to participate in the remote conversation, and causes the participant to leave the remote conversation.

As a result, the organizer does not need to take any action against the participant who may be impersonated, which is highly convenient. Furthermore, it becomes possible to improve the security of the remote conversation by promptly removing the participant who is highly likely impersonated from the remote conversation.

### (III) Description of Third Embodiment

### (A) Configuration

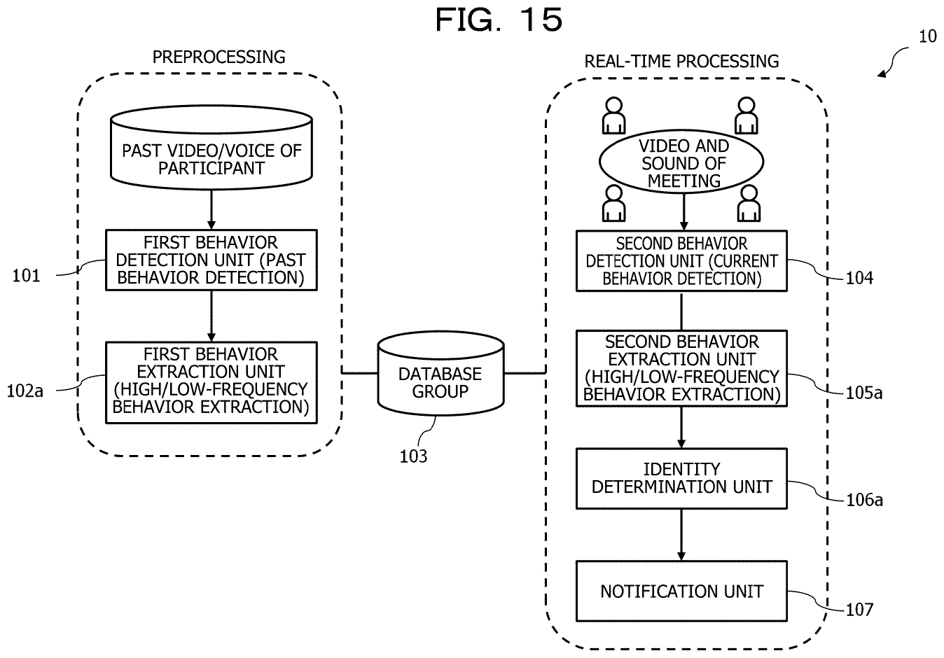

FIG. 15 is a diagram for exemplifying a functional configuration of a computer system 1 as an example of a third embodiment.

As illustrated in this FIG. 15, the computer system 1 according to the third embodiment includes a first behavior extraction unit 102a, a second behavior extraction unit 105a, and an identity determination unit 106a in place of the first behavior extraction unit 102, the second behavior extraction unit 105, and the identity determination unit 106 in the computer system 1 according to the first embodiment, respectively. Other parts are configured in a similar manner to the computer system 1 according to the first embodiment.

In the present third embodiment, a processor 11 executes a determination program to implement functions as a first behavior detection unit 101, the first behavior extraction unit 102a, a second behavior detection unit 104, the second behavior extraction unit 105a, the identity determination unit 106a, and a notification unit 107.

Reference signs same as the aforementioned reference signs denote similar components in the drawing, and thus descriptions thereof will be omitted.

The first behavior extraction unit 102a extracts, for each participant, each of behavior with a high appearance frequency and behavior with a low appearance frequency based on an entire behavior database generated by the first behavior detection unit 101.

The first behavior extraction unit 102a calculates an appearance frequency of an extracted word from all the words uttered by a participant to be determined in the entire video of the participant to be determined. The first behavior extraction unit 102a calculates an appearance frequency of each of all the extracted words included in a phrase to be determined in all the words.

Then, the first behavior extraction unit 102a calculates an average of a logarithmic sum of frequencies of a plurality of extracted words included in the phrase to be determined, thereby calculating an average value of the frequencies of the extracted words for the phrase to be determined.

When the calculated frequency average value of the phrase to be determined is smaller than a threshold T01, the first behavior extraction unit 102a registers the phrase to be determined in a first behavior database 1034 as low-frequency behavior of the participant.

Furthermore, when the calculated frequency average value of the phrase to be determined is larger than a threshold T02, the first behavior extraction unit 102a registers the phrase to be determined in the first behavior database 1034 as high-frequency behavior of the participant.

The second behavior extraction unit 105a extracts each of behavior with a low appearance frequency and behavior with a high appearance frequency from among the phrases (current phrases) detected by the second behavior detection unit 104 in the remote conversation in progress in real time (currently in progress).

The second behavior extraction unit 105a checks whether a phrase that matches the phrase detected in the remote conversation in progress in real time (currently in progress) is registered in the first behavior database 1034 as a low-frequency phrase or a high-frequency phrase of the same participant.

As a result of this checking, when the same phrase as the current phrase is registered in the first behavior database 1034 as a low-frequency phrase, a pair of those current phrase and past low-frequency phrase (low-frequency pair) is generated.

Furthermore, when the same phrase as the current phrase is registered in the first behavior database 1034 as a high-frequency phrase, a pair of those current phrase and past high-frequency phrase (high-frequency pair) is generated.

The low-frequency pair and the high-frequency pair generated by the second behavior extraction unit 105a are generated on the assumption that utterers of the respective phrases have the same account.

It is preferable that the second behavior extraction unit 105a generates a plurality of (N) high-frequency pairs and low-frequency pairs.

Information regarding the high-frequency pair and the low-frequency pair generated in this manner may be stored in, for example, a predetermined area of a memory 12 or a storage device 13.

The identity determination unit 106a determines whether the participant who has uttered the current phrase is the same as the participant who has uttered the past low-frequency phrase based on the high-frequency pair and the low-frequency pair generated by the second behavior extraction unit 105a using the same account.

In the computer system 1 as an example of the present third embodiment, the identity determination unit 106a determines that there is a possibility of spoofing when the following determination conditions 1 and 2 are not satisfied.

Condition 1: matching degree of high-frequency behavior<threshold Th, matching degree of low-frequency behavior<threshold T1

Condition 2: (matching degree of low-frequency behavior)-(matching degree of high-frequency behavior)>threshold Td

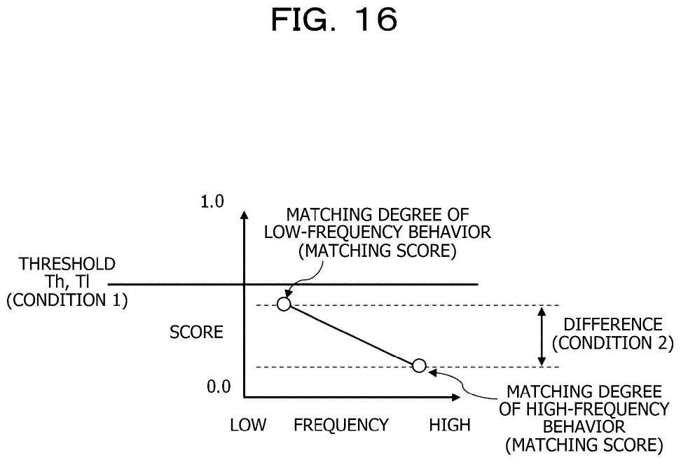

FIG. 16 is a diagram for explaining a technique of determining a possibility of spoofing by the identity determination unit 106a in the computer system 1 as an example of the third embodiment.

In this FIG. 16, a matching degree (matching score) of high-frequency behavior and a matching degree (matching score) of low-frequency behavior are illustrated in two-dimensional coordinates in which the horizontal axis represents a frequency and the vertical axis represents a matching score.

The matching degree of the high-frequency behavior is lower than the threshold Th, and the matching degree of the low-frequency behavior is lower than the threshold T1, which satisfies the condition 1 described above.

When a difference between the matching degree of the low-frequency behavior and the matching degree of the high-frequency behavior is large with respect to the same participant, there is a high possibility of spoofing. In view of the above, when the difference between the matching degree of the low-frequency behavior (matching degree of the low-frequency pair) and the matching degree of the high-frequency behavior (matching degree of the high-frequency pair) is larger than the predetermined threshold Td (condition 2), the identity determination unit 106a determines that the participant who has uttered the current phrase is not the same as the participant who has uttered the past phrase.

The identity determination unit 106a obtains a matching degree (matching scores L1 to Ln) between second feature information (low-frequency behavior) having a frequency lower than the threshold T1 (fourth reference value) extracted from the video of the ongoing remote conversation held in real time among the plurality of participants and second feature information (low-frequency behavior) extracted from the video (second sensing data) of the remote conversation held among the participants in the past.

Furthermore, the identity determination unit 106a obtains a matching degree (matching scores H1 to Hn) between first feature information (high-frequency behavior) having a frequency higher than the threshold Th (fifth reference value) extracted from the video of the ongoing remote conversation held in real time among the plurality of participants and first feature information (high-frequency behavior) extracted from the video (second sensing data) of the remote conversation held among the participants in the past.

Then, the identity determination unit 106a determines that spoofing has occurred when the number of pairs in which a difference of those matching degrees (L1-H1, L2-H2, . . . , Ln-Hn) is smaller than the threshold Td (sixth reference value) is equal to or larger than a threshold Tn (seventh reference value).

### (B) Operation

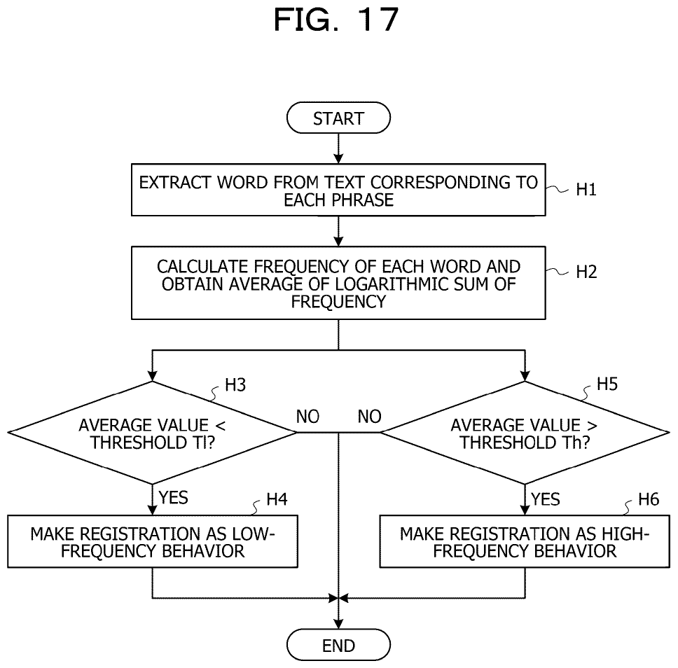

Next, a process of the first behavior extraction unit 102a in the computer system 1 as an example of the third embodiment will be described with reference to a flowchart (steps H1 to H6) illustrated in FIG. 17.

The entire behavior database for all the participants generated by the first behavior detection unit 101 is input to the first behavior extraction unit 102a.

In step H1, the first behavior extraction unit 102a obtains the text corresponding to the phrase (phrase to be determined) from a first phrase corresponding text storage database 1031.

In step H2, the first behavior extraction unit 102a calculates an appearance frequency of the extracted word from all the words uttered by the participant to be determined in the entire video of the participant to be determined. The first behavior extraction unit 102 calculates the appearance frequency of each of all the extracted words included in the phrase to be determined in all the words.

The first behavior extraction unit 102a calculates an average of a logarithmic sum of frequencies of a plurality of extracted words included in the phrase to be determined, thereby calculating an average value of the frequencies of the extracted words for the phrase to be determined.

In step H3, the first behavior extraction unit 102a checks whether the calculated frequency average value of the phrase to be determined is smaller than the threshold T1. For example, the threshold T1=−1000 may be set. As a result of the checking, if the calculated frequency average value of the phrase to be determined is smaller than the threshold T1 (see YES route of step H3), the process proceeds to step H4.

In step H4, the first behavior extraction unit 102a registers the phrase to be determined in the first behavior database 1034 as low-frequency behavior of the participant. Thereafter, the process is terminated.

Furthermore, as a result of the checking in step H3, if the calculated frequency average value of the phrase to be determined is equal to or larger than the threshold T1 (see NO route of step H3), step H4 is skipped, and the process is terminated.

Furthermore, in step H5, the first behavior extraction unit 102a checks whether the calculated frequency average value of the phrase to be determined is larger than the threshold Th. For example, the threshold Th=−100 may be set. As a result of the checking, if the calculated frequency average value of the phrase to be determined is larger than the threshold Th (see YES route of step H5), the process proceeds to step H6.

In step H6, the first behavior extraction unit 102a registers the phrase to be determined in the first behavior database 1034 as high-frequency behavior of the participant. Thereafter, the process is terminated.

Furthermore, as a result of the checking in step H5, if the calculated frequency average value of the phrase to be determined is equal to or smaller than the threshold Th (see NO route of step H5), step H6 is skipped, and the process is terminated.

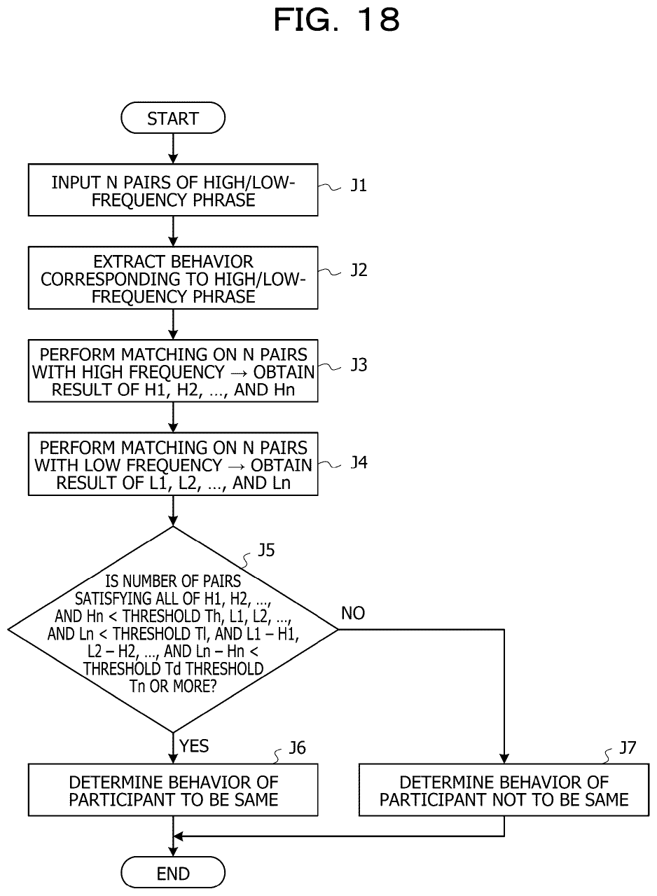

Next, a process of the identity determination unit 106a in the computer system 1 as an example of the third embodiment will be described with reference to a flowchart (steps J1 to J7) illustrated in FIG. 18.

In step J1, N pairs of the current phrase and the past low-frequency phrase generated by the second behavior extraction unit 105a using the same account are input to the identity determination unit 106a.

In step J2, the identity determination unit 106a obtains N pairs of the current phrase and the past low-frequency phrase (low-frequency pairs) and N pairs of the current phrase and the past high-frequency phrase (high-frequency pairs).

In step J3, the identity determination unit 106a obtains matching scores H1 to Hn between the current behavior (voice signal corresponding to the current phrase) and the past behavior (voice signal corresponding to the past high-frequency phrase) for each of the N pairs (high-frequency pairs) of the current phrase and the past high-frequency phrase.

In step J4, the identity determination unit 106a obtains matching scores L1 to Ln between the current behavior (voice signal corresponding to the current phrase) and the past behavior (voice signal corresponding to the past low-frequency phrase) for each of the N pairs (low-frequency pairs) of the current phrase and the past low-frequency phrase.

In step J5, the identity determination unit 106a compares each of the obtained matching scores H1 to Hn with the threshold Th, and checks whether each of the matching scores H1 to Hn is lower than the threshold Th (condition A). For example, the threshold Th=0.25 may be set.

Furthermore, the identity determination unit 106a compares each of the obtained matching scores L1 to Ln with the threshold T1, and checks whether each of the matching scores L1 to Ln is lower than the threshold T1 (condition B). For example, the threshold T1=0.25 may be set.

Moreover, the identity determination unit 106a calculates each difference in matching scores L1-H1, L2-H2, . . . , Ln-Hn, and checks whether the number of pairs satisfying a condition that the difference in those matching scores is smaller than the threshold Td is equal to or larger than the threshold Tn (condition C). For example, the threshold Td=0.1 may be set, and the threshold Tn=2 may be set.

As a result of the checking, if all of the conditions A, B, and C are satisfied (see YES route of step J5), the process proceeds to step J6.

In step J6, the identity determination unit 106a determines that the participant who has uttered the current phrase is the same as the participant who has uttered the past phrase. Thereafter, the process is terminated.

On the other hand, as a result of the checking in step J5, if at least one of the conditions A, B, or C is not satisfied (see NO route of step J5), the process proceeds to step J7.

In step J7, the identity determination unit 106a determines that the participant who has uttered the current phrase is not the same as the participant who has uttered the past phrase. Thereafter, the process is terminated.

### (C) Effects

As described above, according to the computer system 1 as an example of the third embodiment, action effects similar to those of the first embodiment described above may be obtained.

Furthermore, when the identity determination unit 106 determines that the participant who has uttered the current phrase is not the same as the participant who has uttered the past low-frequency phrase, the authority change unit 108 revokes the authority of the participant (account) to participate in the remote conversation, and causes the participant to leave the remote conversation.

As a result, the organizer does not need to take any action against the participant who may be impersonated, which is highly convenient. Furthermore, it becomes possible to improve the security of the remote conversation by promptly removing the participant who is highly likely impersonated from the remote conversation.

### (IV) Description of Fourth Embodiment

### (A) Configuration

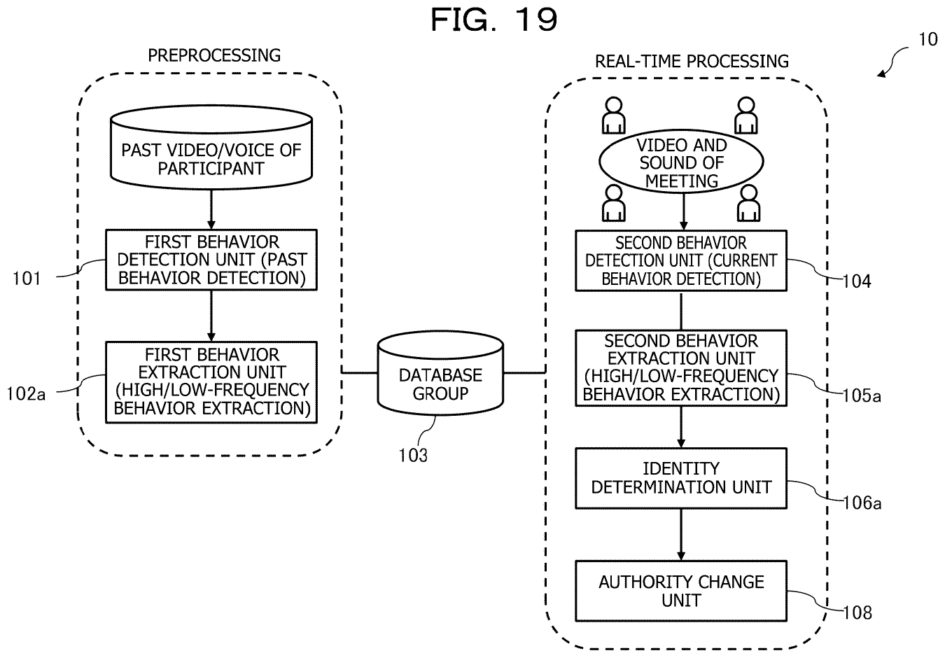

FIG. 19 is a diagram exemplifying a functional configuration of a computer system 1 as an example of a fourth embodiment.

As illustrated in this FIG. 19, the computer system 1 according to the fourth embodiment includes an authority change unit 108 in place of the notification unit 107 in the computer system 1 according to the third embodiment, and other parts are configured in a similar manner to the computer system 1 according to the third embodiment.

In the present fourth embodiment, a processor 11 executes a determination program to implement functions as a first behavior detection unit 101, a first behavior extraction unit 102a, a second behavior detection unit 104, a second behavior extraction unit 105a, an identity determination unit 106a, and the authority change unit 108.

Reference signs same as the aforementioned reference signs denote similar components in the drawing, and thus descriptions thereof will be omitted.

### (B) Effects

As described above, according to the computer system 1 as an example of the fourth embodiment, action effects similar to those of the third embodiment described above may be obtained.

Furthermore, when the identity determination unit 106 determines that the participant who has uttered the current phrase is not the same as the participant who has uttered the past low-frequency phrase, the authority change unit 108 revokes the authority of the participant (account) to participate in the remote conversation, and causes the participant to leave the remote conversation.

As a result, the organizer does not need to take any action against the participant who may be impersonated, which is highly convenient. Furthermore, it becomes possible to improve the security of the remote conversation by promptly removing the participant who is highly likely impersonated from the remote conversation.

### (V) Others

Further, the disclosed technology is not limited to the embodiments described above, and various modifications may be made and implemented in a range without departing from the gist of the present embodiments. Each configuration and each processing of the present embodiments may be selected or omitted as needed, or may be appropriately combined.

While an exemplary case of performing spoofing detection in a remote conversation held among users (participants) of the participant terminals 2 has been described in each of the embodiments described above, it is not limited to this. The user (organizer) of the organizer terminal 3 may participate in the remote conversation. In that case, the organizer also corresponds to the participant.

Furthermore, while the first behavior extraction unit 102 calculates the appearance frequency of each of all the extracted words included in the phrase to be determined in all the words and calculates the frequency average value of the phrase to be determined in each of the embodiments, it is not limited to this. For example, the first behavior extraction unit 102 may use a term frequency-inverse document frequency (tf-idf).

While the first behavior extraction unit 102 calculates the appearance frequency of the extracted word from all the words uttered by the participant to be determined in the entire video of the participant to be determined in each of the embodiments described above, it is not limited to this. For example, the first behavior extraction unit 102 may calculate the appearance frequency of the extracted word from all the words uttered by all the participants in the entire video of all the participants.

While either the notification unit 107 or the authority change unit 108 is provided in each of the embodiments described above, it is not limited to this, and both the notification unit 107 and the authority change unit 108 may be provided.

Furthermore, those skilled in the art may carry out or manufacture the present embodiments according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for determination that causes a computer to execute a process comprising:
obtaining, when first sensing data associated with an account of a participant in a remote conversation is received, feature information of a motion, voice, or a state or any combination of a motion, voice, or a state of the participant, the feature information being extracted from past second sensing data of the participant and having an extraction frequency lower than a first reference value; and
making a determination related to spoofing based on a matching degree between the feature information extracted from the first sensing data and the feature information extracted from the second sensing data.

2. The method according to claim 1, wherein
the making the determination related to the spoofing includes:
calculating the matching degree for each of a plurality of pairs of the feature information extracted from the first sensing data and the feature information extracted from the second sensing data; and
determining that the spoofing has occurred when a number of the pairs in which the matching degree is lower than a second reference value is smaller than a third reference value.

3. The method according to claim 1, wherein
the feature information includes a phrase uttered by the participant, and
the obtaining the feature information includes:
comparing, with the first reference value, the extraction frequency of a phrase calculated based on an appearance frequency of each of a plurality of words included in the phrase uttered by the participant among all words uttered by the participant in entire video of the participant.

4. The method according to claim 1, wherein
the first sensing data includes video in which the participant is imaged in the remote conversation in progress with the participant, and
the second sensing data includes video in which the participant is imaged in the remote conversation previously held with the participant.

5. The method according to claim 1, wherein
the making the determination related to the spoofing includes:
determining that the spoofing has occurred when a number of pairs in which a difference between the matching degree between second feature information with the frequency of extraction from the first sensing data lower than a fourth reference value and the second feature information extracted from the second sensing data and the matching degree between first feature information with the frequency of extraction from the first sensing data higher than a fifth reference value and the first feature information extracted from the second sensing data is smaller than a sixth reference value is equal to or larger than a seventh reference value.

6. The method according to claim 1, wherein the process further comprising:
outputting notification information that indicates that the spoofing has occurred when the spoofing is determined to have occurred.

7. The method according to claim 1, wherein the process further comprising:
revoking authority to participate in the remote conversation from the account of the participant who is a target of the spoofing when the spoofing is determined to have occurred.

8. A non-transitory computer-readable recording medium storing a determination program that causes a computer to execute a process comprising:
obtaining, when first sensing data associated with an account of a participant in a remote conversation is received, feature information of a motion, voice, or a state or any combination of a motion, voice, or a state of the participant, the feature information being extracted from past second sensing data of the participant and having an extraction frequency lower than a first reference value; and
making a determination related to spoofing based on a matching degree between the feature information extracted from the first sensing data and the feature information extracted from the second sensing data.

9. The non-transitory computer-readable recording medium according to claim 8, wherein
the making the determination related to the spoofing includes:
calculating the matching degree for each of a plurality of pairs of the feature information extracted from the first sensing data and the feature information extracted from the second sensing data; and
determining that the spoofing has occurred when a number of the pairs in which the matching degree is lower than a second reference value is smaller than a third reference value.

10. The non-transitory computer-readable recording medium according to claim 8, wherein
the feature information includes a phrase uttered by the participant, and
the obtaining the feature information includes:
comparing, with the first reference value, the extraction frequency of a phrase calculated based on an appearance frequency of each of a plurality of words included in the phrase uttered by the participant among all words uttered by the participant in entire video of the participant.

11. The non-transitory computer-readable recording medium according to claim 8, wherein
the first sensing data includes video in which the participant is imaged in the remote conversation in progress with the participant, and
the second sensing data includes video in which the participant is imaged in the remote conversation previously held with the participant.

12. The non-transitory computer-readable recording medium according to claim 8, wherein
the making the determination related to the spoofing includes:
determining that the spoofing has occurred when a number of pairs in which a difference between the matching degree between second feature information with the frequency of extraction from the first sensing data lower than a fourth reference value and the second feature information extracted from the second sensing data and the matching degree between first feature information with the frequency of extraction from the first sensing data higher than a fifth reference value and the first feature information extracted from the second sensing data is smaller than a sixth reference value is equal to or larger than a seventh reference value.

13. The non-transitory computer-readable recording medium according to claim 8, the method causing the computer to execute the process further comprising:
outputting notification information that indicates that the spoofing has occurred when the spoofing is determined to have occurred.

14. The non-transitory computer-readable recording medium according to claim 8, the method causing the computer to execute the process further comprising:
revoking authority to participate in the remote conversation from the account of the participant who is a target of the spoofing when the spoofing is determined to have occurred.

15. An information processing apparatus comprising:
a memory; and
a processor coupled to the memory and configured to:
obtain, when first sensing data associated with an account of a participant in a remote conversation is received, feature information of a motion, voice, or a state or any combination of a motion, voice, or a state of the participant, the feature information being extracted from past second sensing data of the participant and having an extraction frequency lower than a first reference value; and
make a determination related to spoofing based on a matching degree between the feature information extracted from the first sensing data and the feature information extracted from the second sensing data.

16. The information processing apparatus according to claim 15, wherein the processor:
calculates the matching degree for each of a plurality of pairs of the feature information extracted from the first sensing data and the feature information extracted from the second sensing data; and
determines that the spoofing has occurred when a number of the pairs in which the matching degree is lower than a second reference value is smaller than a third reference value.

17. The information processing apparatus according to claim 15, wherein
the feature information includes a phrase uttered by the participant, and
the processor:
compares, with the first reference value, the extraction frequency of a phrase calculated based on an appearance frequency of each of a plurality of words included in the phrase uttered by the participant among all words uttered by the participant in entire video of the participant.

18. The information processing apparatus according to claim 15, wherein
the first sensing data includes video in which the participant is imaged in the remote conversation in progress with the participant, and
the second sensing data includes video in which the participant is imaged in the remote conversation previously held with the participant.

19. The information processing apparatus according to claim 15, wherein
the processor determines that the spoofing has occurred when a number of pairs in which a difference between the matching degree between second feature information with the frequency of extraction from the first sensing data lower than a fourth reference value and the second feature information extracted from the second sensing data and the matching degree between first feature information with the frequency of extraction from the first sensing data higher than a fifth reference value and the first feature information extracted from the second sensing data is smaller than a sixth reference value is equal to or larger than a seventh reference value.

20. The information processing apparatus according to claim 15, wherein the processor outputs notification information that indicates that the spoofing has occurred when the spoofing is determined to have occurred.
